(19) United States
(12) Patent Application Publication
(10) Pub. No.: US 2011/0258100 A1
(43) Pub. Date: Oct. 20, 2011

(54) Systems, methods, and media for placing orders to trade securities

(75) Inventors: Srikant Krishna, Holmdel, NJ (US); Biquan Lin, Cranbury, NJ (US)

(73) Assignee: BNY CONVERGEX GROUP LLC, New York, NY (US)

(21) Appl. No.: 12/761,143

(22) Filed: Apr. 15, 2010

(51) Int. Cl. G06Q 40/00; G06Q 90/00

(52) U.S. Cl. 705/37; 705/500

(57) ABSTRACT

Systems, methods, and media for placing orders to trade a security are provided. In some embodiments, for example, methods comprise: receiving an order to trade a security; determining an execution rate for the order, determining a darkness threshold for the order; selecting one or more routes for one or more working orders of the order based on at least the darkness threshold; scoring the one or more routes; allocating size to the one or more working orders based on the scoring and the execution rate; creating the one or more working orders; and sending the one or more working orders to the one or more routes for execution.

### TECHNICAL FIELD

The present invention relates to systems, methods, and media for placing orders to trading securities.

### BACKGROUND

When trading securities (e.g., stocks, bonds, funds, etc.), there can be many transactional cost components associated with such trading. For example, these costs can include commissions, opportunity risk, liquidity impact, spread, and information leakage. For example, commissions can include fees paid to an execution agent, whether a broker, liquidity pool or exchange. Opportunity risk can include a cost represented as a function of time and volatility corresponding to the residual, unexecuted portion of the order. Liquidity impact can include a cost associated with demanding liquidity in a given situation. Spread can include a cost associated with crossing the bid/ask spread. Information leakage can include a cost that corresponds to features of the execution process that are observed and adversely affect the price.

The degree of precision to which these quantities can be estimated varies tremendously. Commission and spread can be roughly measured but are time-dependent based on the manner in which liquidity is procured. The liquidity impact at any given moment is more difficult to predict a priori given the prominence of iceberg orders and best execution principles. Opportunity risk is even more difficult to gauge, as it corresponds to the time-dependent volatility of an instrument, and interaction with the market can affect this variable. Finally, the most nebulous factor for which an estimate is required is information leakage. A transaction cost model conceptually treats the execution process as one in which the market risk associated with a client order is continually reduced through trading. However, this risk mitigation is offset by liquidity impact, information dissemination, and the spread.

Accessing dark pools achieves much in terms of minimizing liquidity impact, information leakage, and price improvement against the spread. However, a major concern is market risk. In volatile market situations or with stocks that generally exhibit a high degree of this property, the actual average price over the course of the order may substantially deviate from the arrival price. Therefore, if a stock price is expected to move away quickly, an aggressive style of trading may be preferred. It is also important to consider that security prices that are moving away quickly from a given price are less likely to be crossed on dark pools (due to adverse selection).

Another important concern pertains to the circumstances in which one would wish to employ a tactical trading algorithm versus arrival price (AP) or implementation shortfall (IS) algorithms. In the IS methodology, an execution trajectory is computed in a quantitative manner incorporating estimates of the previously described trading costs. However, the vast degree of uncertainty regarding information dissemination and the other variables renders AR/IS models relatively ineffective when dealing with illiquid names or high participation rates. In order to mitigate this cost (which can be rather substantial), tactical trading offers a compelling alternative. The objective of adherence to a strict IS trajectory is instead replaced by a desire to achieve maximum execution per unit of impact based on observation and interaction with the market.

Implementation shortfall (IS) is currently the most widely used benchmark to measure the execution cost in algorithmic trading. It is defined as the difference between the average execution price and the arrival price. The objective of a trading strategy is to minimize this execution cost.

Liquidity impact is one of the most important factors in execution cost. In a nutshell, the expected value of execution cost will be negatively impacted by trading too fast. This expected cost can be minimized by trading as slowly as possible. However, the variance of the implementation shortfall increases by trading slowly due to opportunity cost. Most current trading algorithms try to determine the optimal trading rate by balancing the expected value against the variance of the total cost.

One conventional approach in implementation shortfall minimization involves regarding the liquidity impact coefficient as a constant throughout the course of the trade. Hence, execution trajectories can be computed a priori based on historical volumes. An improvement to this method involves using a percentage of realtime market volume (POV) in order to account for significant deviations in liquidity from historical data. Furthermore, additional enhancements include forecasting volume through the remainder of the execution.

There are two issues with this conventional approach to algorithmic trading. Firstly, it is difficult to determine what the liquidity impact will be at a particular instant during execution. The notion of employing a coefficient derived from historical data may on average be useful, but the uncertainty is substantial when dealing with individual orders. Without prior information on the current market, the historical data provides the best estimation of the market impact in terms of minimum error of mean value. Secondly, the procurement of liquidity can be negatively impacted by information leakage to other market participants.

### SUMMARY

Systems, methods, and media for placing orders to trade a security are provided. In some embodiments, for example, methods comprise: receiving an order to trade a security; determining an execution rate for the order, determining a darkness threshold for the order; selecting one or more routes for one or more working orders of the order based on at least the darkness threshold; scoring the one or more routes; allocating size to the one or more working orders based on the scoring and the execution rate; creating the one or more working orders; and sending the one or more working orders to the one or more routes for execution.

In some embodiments, for example, systems for placing orders to trade a security are provided, the systems comprising: at least one processor that: receives an order to trade a security; determines an execution rate for the order; determines a darkness threshold for the order; selects one or more routes for one or more working orders of the order based on at least the darkness threshold; scores the one or more routes; allocates size to the one or more working orders based on the scoring and the execution rate; creates the one or more working orders; and sends the one or more working orders to the one or more routes for execution

In some embodiments, for example, computer-readable meda containing computer-executable instructions that, when executed by a processor, cause the processor to perform a method for placing orders to trade a security are provided, the method comprising: receiving an order to trade a security; determining an execution rate for the order; determining a darkness threshold for the order; selecting one or more routes for one or more working orders of the order based on at least the darkness threshold; scoring the one or more routes; allocating size to the one or more working orders based on the scoring and the execution rate; creating the one or more working orders; and sending the one or more working orders to the one or more routes for execution

### BRIEF DESCRIPTION OF THE DRAWINGS

FIG. 1 is a block diagram of hardware that can be used in some embodiments.

FIG. 2 is a flow diagram of a process for a routing order engine that can be used in accordance with some embodiments.

FIG. 3 is a diagram of a user interface for submitting orders that can be used in accordance with some embodiments.

FIG. 4 is a flow diagram of an initialization process that can be used in accordance with some embodiments.

FIG. 5 is a flow diagram of a process for processing orders that can be used in accordance with some embodiments.

FIG. 6 is a flow diagram of a process for determining an execution rate and an order more that can be used in accordance with some embodiments.

FIG. 7 is a flow diagram of a process for determining a darkness threshold that can be used in accordance with some embodiments.

FIG. 8 is a flow diagram of a process for determining routes and sending working orders that can be used in accordance with some embodiments.

FIG. 9 is a flow diagram of a process for filtering routes that can be used in accordance with some embodiments.

### DETAILED DESCRIPTION

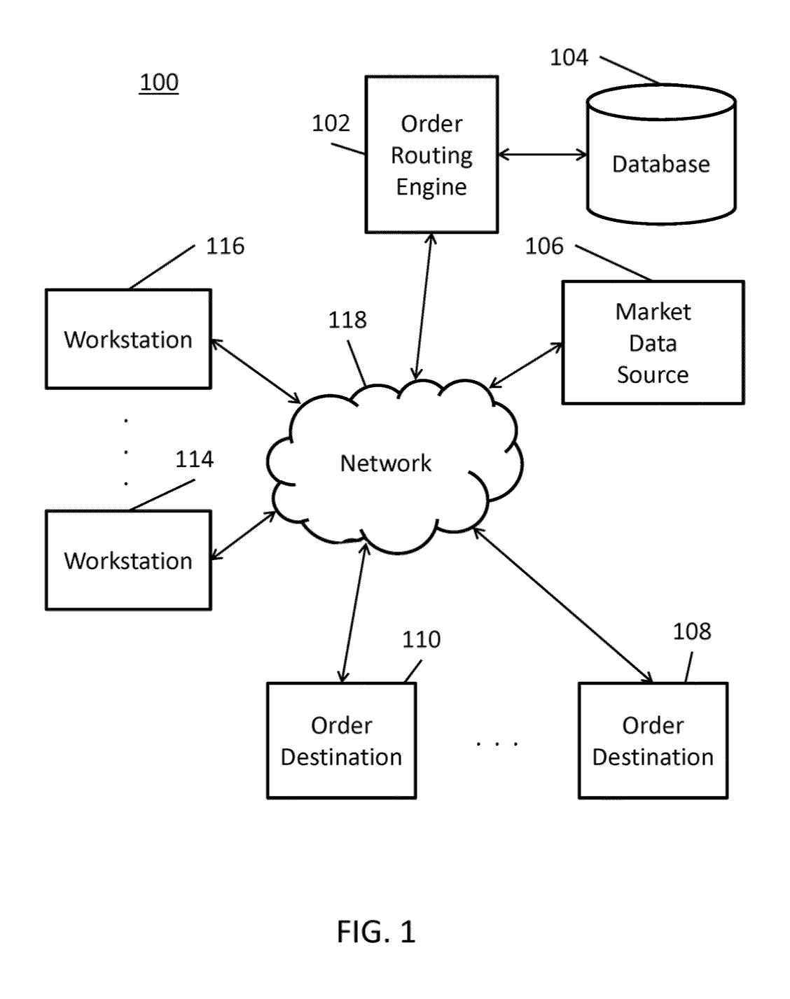

Turning to FIG. 1, an example of a system configuration 100 that can be used for sizing and routing trade orders in accordance with some embodiments is illustrated. As shown, configuration 100 includes an order routing engine 102, a database 104, a market data source 106, order destinations 108 and 110, workstations 114 and 116, and a network 118.

Order routing engine 102 can be implemented using any suitable hardware and/or software. For example, order routing engine can be implemented in a general purpose device such as a computer or a special purpose device such as a client, a server, etc. Any of these general or special purpose devices can include any suitable components such as a processor (which can be a microprocessor, digital signal processor, a controller, etc.), memory, communication interfaces, display controllers, input devices, etc., and can be configured to operate in response to software instructions consistent with the functionality described herein. Although only one order routing engine 102 is shown in FIG. 1, any suitable number of engines 102 can be implemented, and some such engines may include functions not included in other such engines.

Database 104 can be any suitable database and can be implemented in any suitable hardware and/or software. In some embodiments, database 104 can be implemented in the same physical device as order routing engine 102. Although only one database 104 is shown in FIG. 1, any suitable number of databases 104 can be implemented, and some such databases may include data and/or functions not includes in other such databases.

Market data source 106 can be any suitable source of market data, and can provide any suitable market data. For example, market data source can be implemented using any suitable hardware and/or software. Although only one market data source 106 is shown in FIG. 1, any suitable number of market data sources can be used in some embodiments, and some such market data sources can provide data not provided by other such market data sources.

Order destinations 108 and 110 can be any suitable destinations for routing orders. For example, order destinations can include stock market exchanges (e.g., such as the New York Stock Exchange, the American Stock Exchange, etc.), secondary exchanges, matching engines, dark pools, etc. Although only two order destinations are shown in FIG. 1, any suitable number of order destinations can be implemented.

Workstations 114 and 116 can be implemented using any suitable hardware and/or software. For example, workstations can be implemented in a general purpose device such as a computer or a special purpose device such as a client, a server, etc. Any of these general or special purpose devices can include any suitable components such as a processor (which can be a microprocessor, digital signal processor, a controller, etc.), memory, communication interfaces, display controllers, input devices, etc., and can be configured to operate in response to software instructions consistent with the functionality described herein. Although only two workstations are shown in FIG. 1, any suitable number of workstations can be implemented, and some such workstations may include functions not included in other such workstation.

Network 118 can be any suitable communication network for communicating data between order routing engine 102, database 104, market data source 106, order destinations 108 and 110, and/or workstations 114 and 116. For example, network 118 can include the Internet, wired networks, wireless networks, local area networks, wide area networks, telephone networks, cable networks, satellite networks, etc.

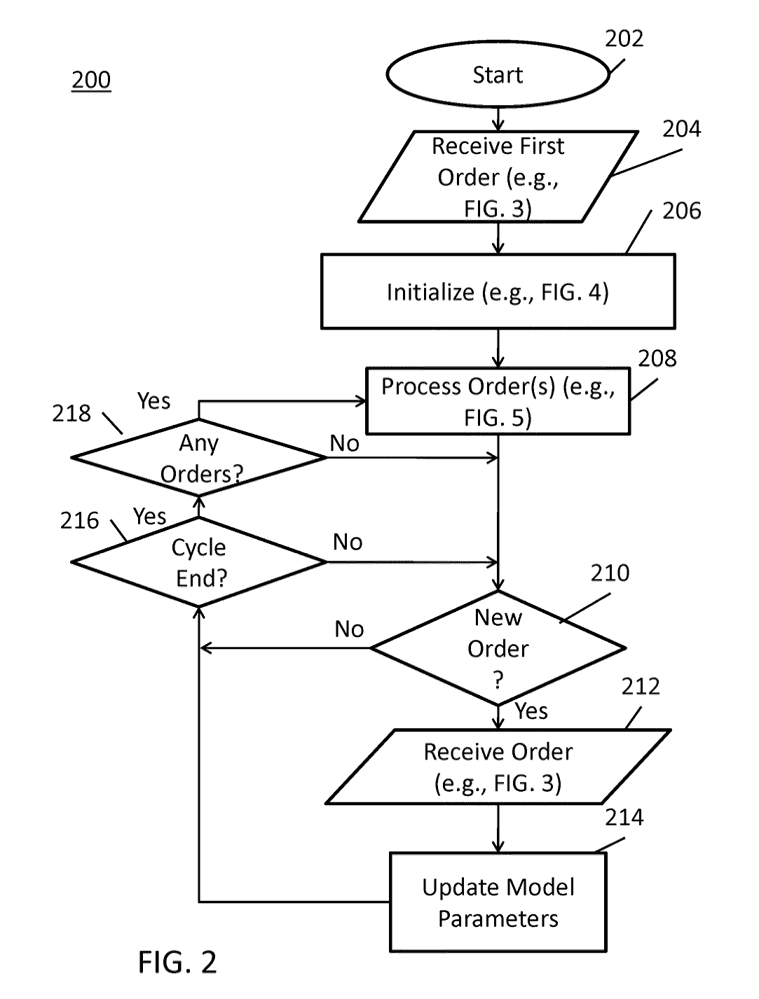

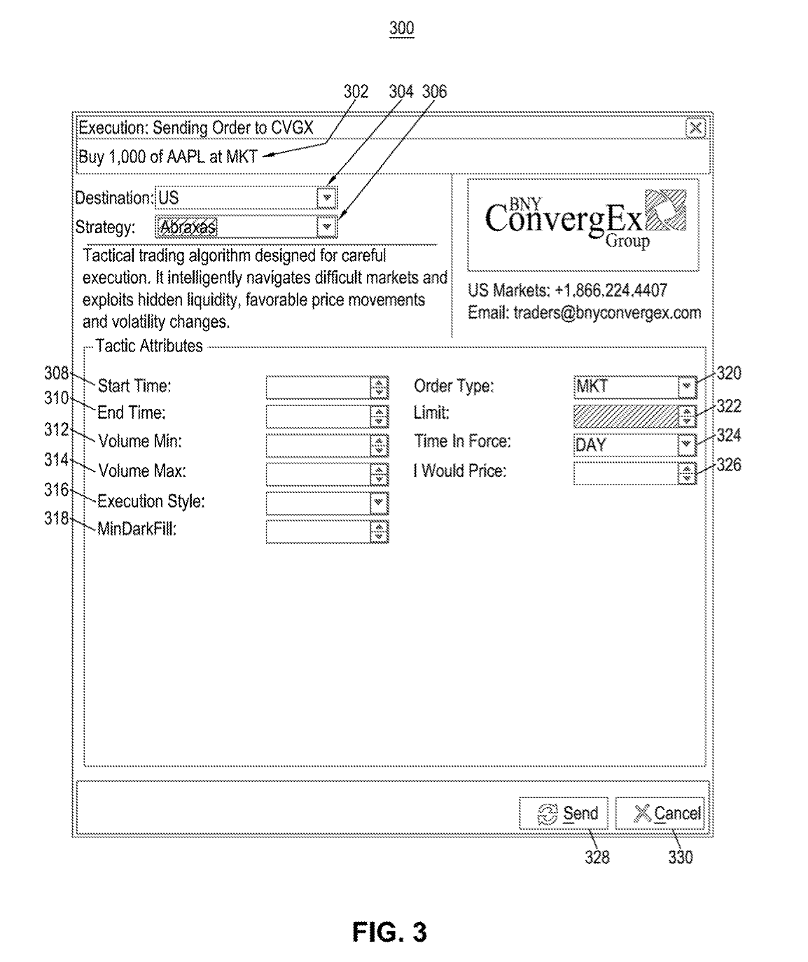

Turning to FIG. 2, an example of a process 200 that can be executed in order routing engine 102 in accordance with some embodiments is illustrated. As shown, after process 200 begins at 202, the process waits for and receives its first order at 204. An order can be received from any suitable source, device, or mechanism, such as one of workstations 114 and 116. For example, in some embodiments, an order can be received from a software application being executed on a workstation 114 or 116 that presents a graphical user interface 300 as shown in FIG. 3.

As illustrated in FIG. 3, such an interface 300 can indicate in a field 302 that an order to buy 1,000 shares of the stock represented by the symbol “AAPL” at the market price is to be placed. As shown in fields 304 and 306, the destination for this order can be the United States and the strategy for placing the order can be to use the “Abraxas” trading engine (which is described herein). Using interface 300, a user can specify a start time and a stop time for the order placement (fields 308 and 310), a percentage of traded volume minimum and a percentage of traded volume maximum (fields 312 and 314), an execution style (e.g., “Passive,” “Neutral,” “Aggressive,” “Custom,” “Stealth,” “GetAggressive,” “DarkExclusion,” etc.) (field 316), a minimum dark fill quantity (field 318), an order type (e.g., Market, Limit, etc.) (field 320), a limit price (if a limit order) (field 322), a time in force (e.g., day) (field 324), and an “I would” price (field 326).

The start time and a stop time for the order placement (fields 308 and 310) can be any suitable absolute or relative time values. For example, the start and stop times can specify that the order can be sent to the order routing engine between 12 pm and 2 pm New York time. As another example, the start and stop times can indicate that the order can be sent during the trading day.

The percentage of traded volume minimum and percentage of traded volume maximum (fields 312 and 314) can indicate the minimum and maximum percentages of traded volume that the order can take up. For example, the percentage of traded volume minimum and percentage of traded volume maximum values can specify that the order is to be between 10% and 20% of the percentage of traded volume of the stock.

The execution style (e.g., “Passive,” “Neutral,” “Aggressive,” “Custom,” “Stealth,” “GetAggressive,” “DarkExclusion,” etc.) (field 316) can indicate a style that the user placing the order would like to adopt for executing the order. For example, the execution style can be “Passive” such that the order will be executed relatively slowly (e.g., with a POV rate of 5% to 20%). As another example, the execution style can be “Neutral” such that the order will be executed with medium speed (e.g., with a POV rate of 15%-30%). As yet another example, the execution style can be “Aggressive” such that the order will be executed relatively quickly (e.g., with a POV rate of 20% to 40%). As still another example, the execution style can be “Custom” such that the order will be executed according to parameters provided. As still another example, the execution style can be “Stealth” such that the order will be executed in full when the market liquidity is large enough compared to average daily volume (ADV) or order size. As still another example, the execution style can be “GetAggressive” such that the order will be executed using the Aggressive style when the prevailing market price is near a desired price. As still another example, the execution style can be “DarkExclusion” such that the order will be executed so that any working orders executed in dark pools will not be considered in POV calculations.

The minimum dark fill quantity (field 318) can indicate the minimum quantity (in either absolute or relative terms) of a working order (e.g., one or more child orders to be worked in order to complete a parent order) to be executed in each dark pool. For example, this field can indicate that 200 shares of a working order is to be executed in each dark pool to which one or more working orders are sent.

The order type (e.g., Market, Limit, Pegged, etc.) (field 320) can indicate the type of order. For example, the order type can indicate that the order is a market order, a limit order, a pegged order, etc.

The limit price (if a limit order) (field 322) can indicate the limit price for limit orders. For example, the limit price can indicate that the buy order is to be place once the order drops to a price of $100 per share.

The time in force (e.g., day, open, IOC, close, etc.) (field 324) can indicate the time window during which a working order can be executed at a destination. For example, the time in force can indicate that a working order with an IOC time in force is to be executed immediately or cancelled.

The “I would” price (field 326) can indicate a price at which the entirety of the residual of an order will be issued to the marketplace.

The order can be communicated from a workstation to the order routing engine using any suitable communication protocol. For example, the order can be communicated using one or more Financial Information eXchange (FIX) protocol messages.

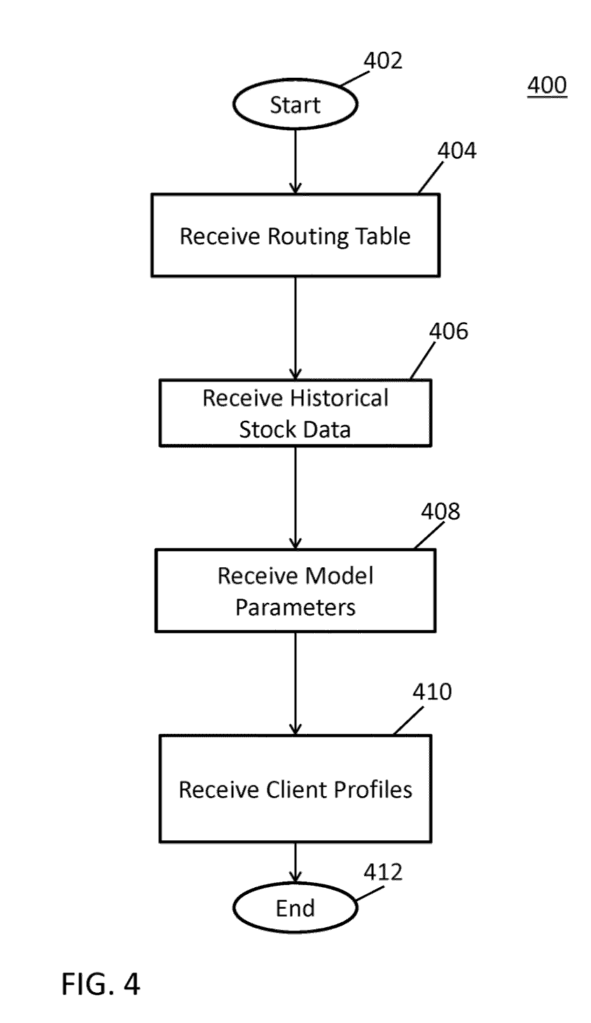

Returning to FIG. 2, once the first order has been received at 204, process 200 can initialize certain parameters used in order routing engine 102. For example, this initialization can be performed as illustrated in FIG. 4 in some embodiments.

As shown, after process 400 has begun at 402, routing tables can be received at 404. Routing tables (which can be stored in database 104, for example) can contain a store of order routes that can be used to direct working orders, and can contain information pertaining to several features of the order route. For example, an order route can be associated with one or more venues (order destinations) as well as time in force (e.g., day, immediate-or-cancel), display type (e.g., reserve, hidden, etc.), order type (e.g., pegged, limit, etc.), execution instructions (e.g., fill at primary, mid, market, etc.), pricing information (e.g., price at primary, mid, contra, etc.), etc. Each row in the route database can also contain one or more fields that convey the adding-liquidity/taking-liquidity cost, special flags, a flag that conveys whether the route is active or not, etc. There can also be an efficiency field that specifies the initial efficiency associated with that route that will be used in the dynamic order placement process (describe below). Finally, there can also be a darkness that is assigned to each route based on an estimate of how much information that employing a particular route will convey to other market participants. For example, darkness can be estimated to be inversely proportional to the amount of information that is anticipated will be leaked when a corresponding route is used.

At 406, historical stock data can be received. Several historical datasets, including a security master, intraday volume, and intraday bid-ask spread data, can be used in some embodiments. These datasets can be computed nightly and stored into database tables (e.g., in database 104) for use the following morning. For example, a security master can include a database table in which names (e.g., “AAPL”) that can be traded are characterized through several fields, including ticker, open, high, low, close, 20-day ADV, 90-day ADV, beta, etc. The historical intraday volume set can include two-minute binned volume data derived from historical trading information for each stock. The averaging procedure can include summing volume for the previous five days, and then normalizing the volume for each bin. Similarly, the historical intraday spread data can include average bid-ask spreads computed in two-minute bins for the previous five days that are also normalized.

At 408, model parameters can be received. The model parameters can include various operational modulators, including sensitivity coefficients, minimum/maximum darkness overrides, and the initial darkness that are used in various aspects of some embodiments as described below.

Client profiles can be received at 410. Client profiles can be, for example, information for specific clients the specifies: order handling parameters and constraints to be implicitly specified when an order is received from a particular sending client; routes that are to be excluded; etc. This information can be organized by an identifier associated with a particular client.

Finally, process 400 can terminate at 412.

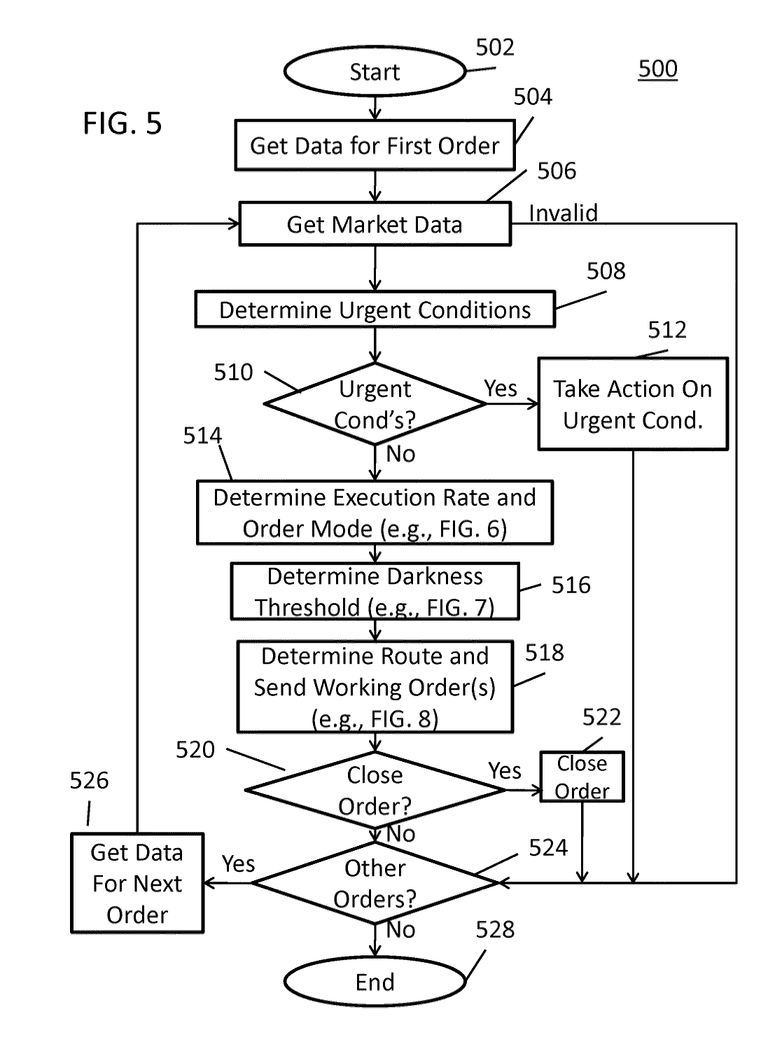

Returning to FIG. 2, after initialization has been performed at 206, the order(s) can be processed at 208. A process 500 for processing orders in accordance with some embodiments is shown in FIG. 5. As illustrated, after process 500 begins at 502, the process first gets data for the first order to be processed at 504. This data can include any suitable data relating to the order that is needed for subsequent processing.

Next at 506, market data corresponding to the order can be obtained and validated. This market data can be obtained from any suitable source, such as source 106 in FIG. 1. For example, pricing information corresponding to the bid/ask/last of the order can be obtained and checks performed to ensure that the data is valid and consistent. As another example, volume data can also be obtained and used to calculate out-of-the-money volume for limit orders. In some embodiments, if market data corresponding to an order is invalid, the processing of that order can be terminated for the present cycle and the processing repeated in the next execution cycle until valid market data has been received. In some embodiments, invalid market data can result in a counter being incremented, and after the counter has exceeded a certain threshold, the order processing can be prevented from being worked by an “unsolicited out” being issued.

After valid market data for the order is obtained at 506, process 500 can next determine whether there are any urgent conditions for the order at 508. These urgent conditions may require immediate attention and bypass the normal operational flow of process 500. For example, these conditions can include the market price for the security of the order reaching the “I Would” price, being far out of the money with respect to limit orders, hitting a stealth trigger, requiring rapid catch-up to a POV constraint, and cleaning up the order. These urgent conditions can be indicated in any suitable manner. If urgent conditions are present, then process 500 can branch at 510 to 512 to take appropriate action on the urgent condition and then continue to 520 to process other orders.

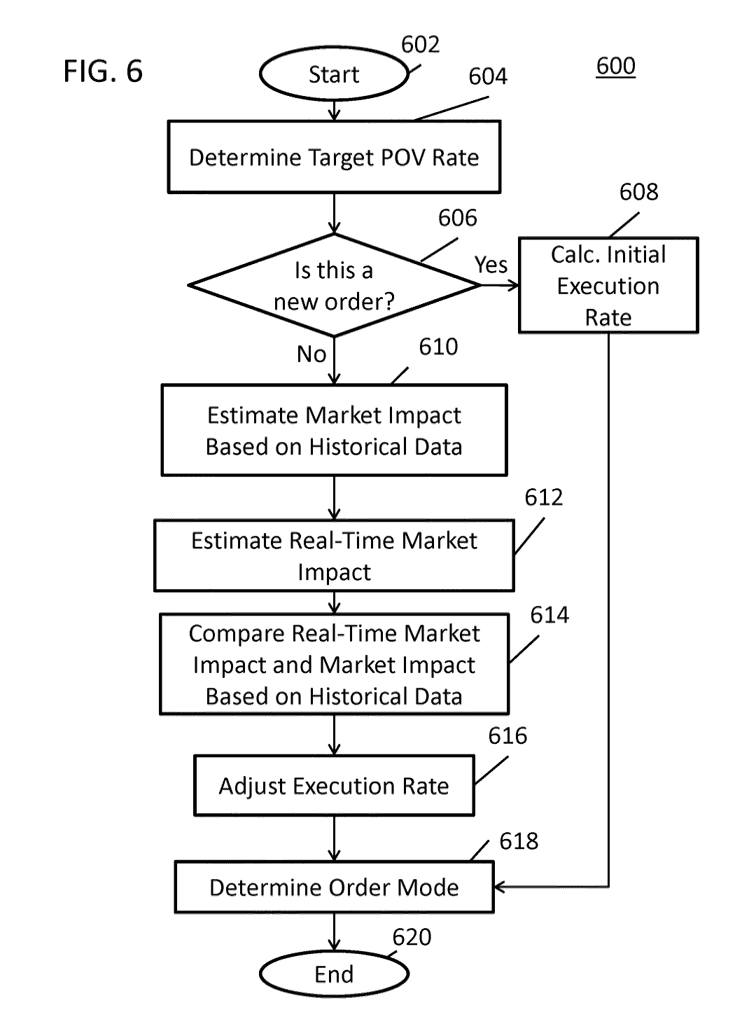

If no urgent conditions are present at 510, then process 500 can determine the execution rate and mode for the order at 514. Any suitable approach for determining the execution rate and mode can be used in some embodiments. For example, in some embodiments, a variable execution rate based on differences between estimated impact and the actual observed impact can be used. For example, the execution rate can be determined by a process 600 as illustrated in FIG. 6.

As shown, after process 600 begins at 602, the process can first determine, at 604, the target POV rate for the order. Any suitable approach to determining the target POV rate can be used. For example, the POV minimum and the POV maximum values set in interface 300 can be used as the floor and the ceiling, respectively, of the participation rate range, and the target POV rate initially set in the middle of this rage. For each subsequent cycle in which working orders are generated, the target participation rate can be determined by applying a sigmoid squashing function in which the domain corresponds to the difference between the current market price of the security in the order and the price for the initial working order in that order, expressed in basis points. In some embodiments, the coefficient employed for this function yields a function that saturates at roughly a 100 basis point movement in either direction.

Next, process 600 can determine, at 606, if the present order is a new order. If so, the process can next determine, at 608, an initial execution rate for the order based on a target POV rate. Any suitable technique for determining the initial execution rate can be used in some embodiments. For example, if the target POV rate is 15%, the order size is 100,000 shares, and the present average daily volume is 200,000 shares per hour, the initial execution rate can be selected to be 30,000 shares per hour.

Otherwise, if the order is determined to not be a new order at 606, process 600 can estimate the market impact of an order based on historical data at 610. Any suitable mechanism can be used to make this estimate. For example, the estimated market impact based on historical data \tilde{K} can be calculated as follows:

$$\tilde{K} = {α}_{1} σ \frac{X}{V} {U}^{β 1} + {α}_{2} {σ ( \frac{X}{VT} )}^{β 2}$$

where α₁, α₂, β1, and β2 are coefficients that can be determined using a linear regression model on historical data (e.g., α₁ can equal 0.157, α₂ can equal 0.142, β1 can equal 0.25, and β2 can equal 0.6), σ is daily volatility, X is the number of shares in the order, V is the average daily volume of the security, T is the trading duration of the order based on the present execution rate, and U is the security turnover ratio.

At 612, process 600 can then estimate the real-time market impact of the order. Any suitable mechanism can be used to make this estimate. For example, in some embodiments, this estimate can be made by comparing observed trading cost against estimated stock price without market impact. As a more particular example, the estimated real-time market impact \hat{K}̂ can be calculated as follows:

\hat{K}=S*(P−\tilde{P})

where S is the number of executed shares, P is the most-recent execution price, and \tilde{P} is the non-impact price. \tilde{P} can be estimated by:

\tilde{P}=P₀+β*r

where β is the multiple of stock return relative to index return in a capital asset pricing model, P₀ is an initiation price for the first trade on the present order, r is an index return in since the first trade on this order. The index return can be chosen based on any suitable index such as the S&P 500 index, a sector index, a basket of correlated stocks, etc.

Next, at 614, process 600 can then compare the estimated real-time market impact against the estimate market impact based on historical data. For example, a sensitivity f_{g} at time t can be calculated as:

f_{g}=\hat{K}ₜ−\tilde{K}ₜ

Then, at 616, the execution rate can be adjusted based on this comparison. For example, if f_{g} is determined to be greater than a certain threshold (which may be sign someone is gaming the market), the trading rate can be reduced by a given amount. If f_{g} is determined to be less than a certain threshold, the trading rate can be increased by a given amount. Any suitable one or more given amounts can be used to reduce or increase the execution rate. For example, the given amount(s) can be determined empirically.

After adjusting the execution rate at 616, or calculating the initial execution rate at 608, process 600 can determine the order mode at 618. Any suitable approach to determining the order mode can be used. For example, in some embodiments, the order mode can be selected based on a comparison of the actual participation rate with POV minimum setting, a POV maximum setting, and a target execution rate. This comparison can be utilized as follows:

If the actual rate is less than the POV minimum: the order can be placed in a POV catch-up mode. In this mode, the order can be issued as a SMART-POST working order followed by a SMART-TAKE working order to ensure that the POV minimum is being adhered to. A SMART-POST working order is a working order in which the orders will be filled at a designated venue called SMART-POST (e.g., BATS take liquidity order on the BATS exchange hosted by BATS EXCHANGE, INC. of Kansas City, Mo.). A SMART-TAKE working order is a working order in which the orders will be filled at a designated venue called SMART-TAKE (e.g., BATS post liquidity order on the BATS exchange hosted by BATS EXCHANGE, INC. of Kansas City, Mo.).

If the POV minimum is less than the actual rate, and the actual rate is less than the target rate: the order can be placed in a TAKE mode. In this mode, route/order-type combinations that are of the taking liquidity variety will be used.

If the actual rate is greater than the target rate, and the actual rate is less than the POV maximum: the order can be place in a POST mode. In this mode, route/order-type combinations that are of the posting liquidity variety will be used.

If the actual rate is greater than the POV maximum: the order can be placed in a STOP mode. In this mode, the issuance of orders will cease until the POV maximum condition is no longer violated. However, in this mode, external factors, such as an “I Would” price being met and so forth, may still elicit execution of an order.

After the mode has been determined, process 600 can end at 614.

Returning to FIG. 5, process 500 can next determine the darkness threshold for the order at 516. The darkness threshold for the order can be used to characterize the amount of information that may be disseminated upon placement of the order at a particular route. Any suitable approach for determining the darkness threshold can be used in some embodiments. For example, in some embodiments, a darkness threshold based on sensitivity factors can be used. Sensitivity factors can be based on any criteria or criterion.

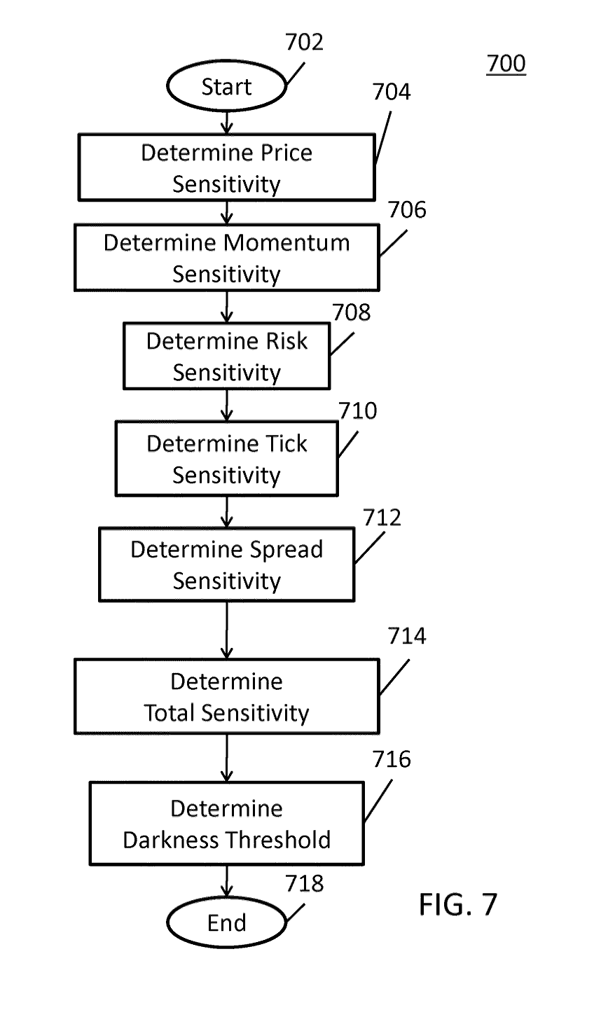

For example, in some embodiments, a process 700 for determining a darkness threshold based on sensitivity factors as illustrated in FIG. 7 can be used. As shown, after process 700 begins at 702, a price sensitivity F_{P} can be calculated, at 704, as the price change in basis points per share (bps) using the following formula:

Fₚ=(P_{c}−Pᵢ)/Pᵢ

where P_{c} is midpoint of current national best bid best offer (NBBO) and Pᵢ is the midpoint when the order arrives.

Next, at 706, a momentum sensitivity F_{M} can be calculated as the autocorrelation of price change using the following formula:

Fₘ=Σ(Xₜ−u)*(Xₜ₋₁−u)/σ²

where Xₜ is the price change from time cycle t-1 to t, u is the mean of the price change and σ is standard deviation in the last 10 minutes sampled at every second.

An alternative way of calculating momentum sensitivity is to use short-term VWAP against long-term VWAP.

At 708, risk sensitivity F_{R} can be calculated as the standard deviation of log-return of the stock in last 10 minutes sampled at each second. In some embodiments, there can be a maximum of 600 data points. In some embodiments, if the total number of points is less than 30, its value will be set to zero.

At 710, tick sensitivity F_{T} can be measured as a hit/take ratio. In some embodiments, the last print at each second for the last 10 minutes can be sampled. Then, the last sale price and the midpoint of the prevailing NBBO can be determined. A z-score can then be computed for the current tick against the distribution of differences for the previous ten minutes. Finally, the tick sensitivity factor can be conveyed as the z-score after multiplication with the tick sensitivity coefficient and user-supplied value.

At 712, spread sensitivity F_{S} can be calculated as the z-score of the spread in last 10 minutes sampled at each second using the following formula:

Fₛ=(s−u)/σ

where s is current spread, u is the mean over the past 10 minutes, and σ is the standard deviation of the spread over the past 10 minutes.

At 714, total sensitivity F can be calculated as the weighted sum of each factor presented above using the following formula:

Total Sensitivity=Σ(wᵢ*aᵢ*Fᵢ)

where i={P,M,R,T,S}, wᵢ is a weight specified by trading style, aᵢ is a scaling factor used to bring a corresponding sensitivity factor to the comparable range, and Fᵢ is the computed value for each sensitivity i. In some embodiments, the scaling factors are determined by statistical techniques, whereas the weights are specified according to the trading style.

At 716, the darkness threshold can be calculated as a sigmoidal function of total sensitivity using the following formula:

d=100*1(1+e^{-kf})

where f is the total sensitivity and k is a scaling coefficient.

If a darkness range is specified by trading style, a cut-off function can be used to derive the final darkness threshold value. For example, when the user specifies a passive trading style, the darkness can be preset to have a range from 60 to 100. In such a case, if the darkness threshold is calculated to be less than 60, the final darkness threshold will nevertheless be cut-off to 60.

Finally, process 700 can end at 718.

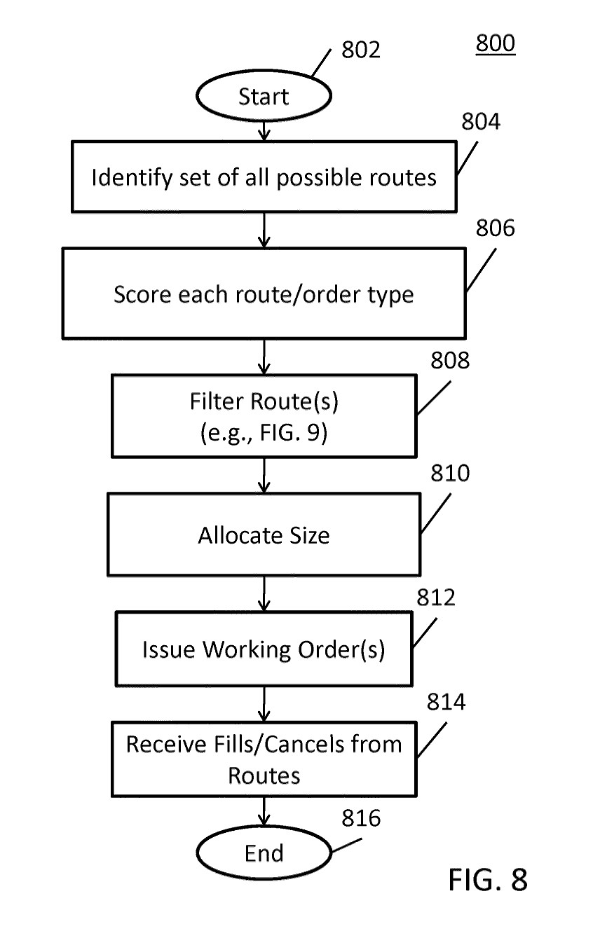

Returning to FIG. 5, after the determinations have been made regarding the execution rate and the darkness threshold at 514 and 516, routes for an order can be determined and working orders for the order can be generated at 518. In some embodiments, the generation of working orders can involve identifying a set of all possible routes, scoring each route/order-type, filtering the routes based on several criteria, allocating size among working orders, issuing working orders, and waiting for responses from the execution venues. These functions can be performed using any suitable mechanisms. For example, routes for an order can be determined and working orders for the order can be generated as illustrated, for example, by process 800 of FIG. 8.

As shown in FIG. 8, after process 800 begins at 802, the set of all possible routes can initially be identified at 804. This identification may be based on any suitable criteria or criterion. For example, the set of all possible routes can be defined in some embodiments by a routing table in database 104.

After the set of all possible routes is identified, each route/order type combination in this set can be scored at 806 to determine the best routes for working orders of the order. Scoring can be performed in any suitable manner. For example, in some embodiments, an efficiency score for a route/order type combination can be calculated based on the following formula:

E_{iraw}=(Fᵢ+Fᵢ₀)/(Sᵢ+Sᵢ₀)

where Fᵢ is the number of shares filled for this symbol, side, and route combination from the beginning of trading session, Sᵢ is the total number of shares sent to this symbol, side, and route combination, and Fᵢ₀ and Sᵢ₀ are corresponding initial value estimates from historical data, also known as pseudo-counts.

Next, at 808, the set of possible routes can be filtered to determine the available routes for working orders of the order. Filtering of the possible routes can be performed based on any suitable criteria or criterion.

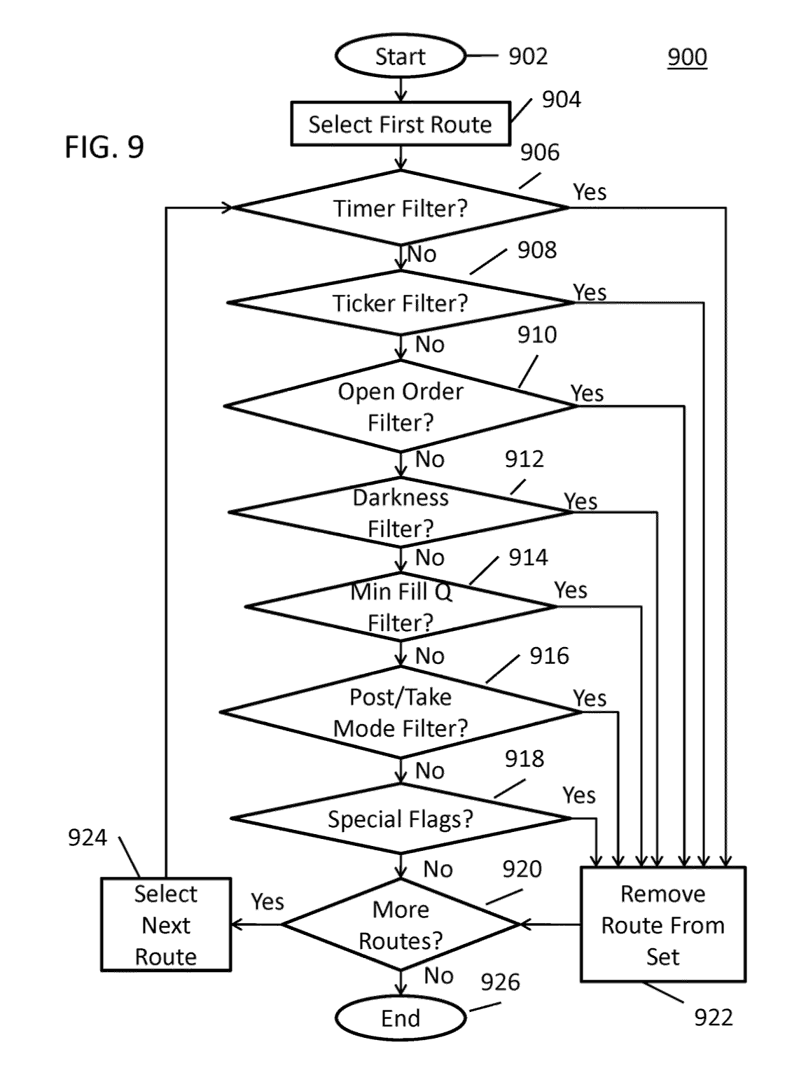

For example, in some embodiments, the possible routes can be filtered by a process 900 as shown in FIG. 9. As illustrated, after process 900 begins at 902, the process can select the first route at 904. Next, the process can determine whether the selected route is to be filtered based on a timer filter for the route 906. The timer filter can insure that only a single working order for an order is associated with a route at any time. For example, if a working order for an order from a previous cycle is pending on a particular route, no new working order from the same order will be routed to the same particular route in some embodiments. If it is determined at 906 that the route is to be timer filtered, then process 900 can branch to 922 where the route is removed from the set of possible routes.

After removing a route from the set of possible routes at 922, process 900 can determine at 920 if there are any more routes. If there are more routes, process 900 can select the next route at 924 and then loop back to 906. Otherwise, process 900 can end at 926.

If the route is not to be timer filtered, then, at 908, the selected route can be filtered based on ticker. Any suitable approach to filtering based on ticker can be used in some embodiments. For example, for a route including the New York. Stock Exchange (NYSE), it is important to determine whether the stock corresponding to a client order is listed on the NYSE or not. Furthermore, some routes do not accept suffixes. Depending on these circumstances, the route may be excluded from the permissible subset. If it is determined at 908 that the route is to be ticker filtered, then process 900 can branch to 922 where the route is removed from the set of possible routes and then proceed as described above.

If the route is not to be ticker filtered, then, at 910, the selected route can be filtered to ensure that there is only one open order for any route/order-type at any time. In other words, this filter can prevent multiple orders from being layered to any route. Therefore, if a route already contains an active order, it will be excluded from the subset of permissible routes. If it is determined at 910 that the route is to be open order filtered, then process 900 can branch to 922 where the route is removed from the set of possible routes and then proceed as described above.

If the route is not to be order filtered, then, at 912, the selected route can be filtered based on a darkness threshold for the order. For example, the darkness threshold may be based on order constraints defined by the user or client or may be based on a darkness threshold calculated based on market conditions (e.g., as in FIG. 7). If it is determined at 912 that the route is to be darkness filtered, then process 900 can branch to 922 where the route is removed from the set of possible routes and then proceed as described above.

If the route is not to be darkness filtered, then, at 914, if the order constraints mandate a minimum fill quantity, the selected route can be filtered based on whether the route can comply with this minimum. If it is determined at 906 that the route is to be minimum fill quantity filtered, then process 900 can branch to 922 where the route is removed from the set of possible routes and then proceed as described above.

If the route is not to be minimum fill quantity filtered, then, at 916, the selected route can be filtered based on whether the order is to engage in a post (adding liquidity) or take (removing liquidity) mode dynamically based on execution rate considerations. In some embodiments, routes may be preconfigured to indicate whether they can engage in post and take modes. If it is determined at 916 that the route is to be filtered based on post or take mode, then process 900 can branch to 922 where the route is removed from the set of possible routes and then proceed as described above.

If the route is not to be filtered based on post or take mode, then, at 918, the selected route can be filter based on flags. Any suitable flags and number of flags (including none) can be used in some embodiments. For example, in some embodiments, these flags can include flags indicating electronic liquidity provider/market maker (ELP/MM) status. If it is determined at 918 that the route is to be flag filtered, then process 900 can branch to 922 where the route is removed from the set of possible routes and then proceed as described above.

Returning to FIG. 8, after the set of routes has been filtered, the size of each working order for the order can be allocated at 810. The size of each working order can be calculated using any suitable approach. For example, in some embodiments, the size can be calculated by multiplying the total size for the order by the normalized efficiency for the corresponding route/order type combination using the formula:

Sᵢ=Sₜₒₜₐₗ*Eᵢ

where Eᵢ represent the normalized efficiency of the destination for the route/order type combination. The normalized efficiency can be calculated using the following formula:

Eᵢ=E_{iraw}/ΣE_{iraw}

where E_{iraw} is the score calculated at 806.

The size calculated can be checked and modified, in some embodiments, to ensure that each working order is within a specified percentage of average daily volume (ADV) to avoid oversized orders, to ensure that there are no odd or mixed lots, and to avoid any overtrading.

Next, at 812, working orders for the order can be issued. Any suitable approach for issuing working orders can be used. For example, in some embodiments, working order issuance can involve first instantiating a new working order, then setting all the fields of the nascent working order according to the route specifications, and finally instantiating and storing a state object corresponding to the working order. The pricing of the order may be dependent on the prevailing quote at the time of working order creation. Timers corresponding to the route can also be updated as part of working order issuance.

Finally, at 814, after working orders have been issued, several responses from an execution venue corresponding to the route/order-type can be received. For example, partial or complete fills indications may be received. As another example, reject indications may be received. In some embodiments, reject indications can be stored and result in the eventual disabling of a route for a period of time if a sufficient quantity of indications has been received. As yet another example, with route/order-types that are of the immediate-or-cancel nature, a cancel indication can be received immediately after an attempt at execution has been made in the venue's execution engine. As still another example, when an order remains open beyond its expiration time, a cancel may be received based on the triggering of a timer. As still another example, urgent conditions (described previously) may also cause cancel indications to be received for an order before the order's expiration time is reached in order to recover the shares for other purposes.

Returning to FIG. 5, after the routes for an order are determined and the working orders generated, process 500 can determine whether to close the order at 520. It can be appropriate to close an order in multiple circumstances including, but not limited to, the user issuing a cancel, the market center being officially closed, or the order being completely filled. If the order is to be closed, the process 500 can close the order at 522.

After the order has been closed at 522, the order is determined to not be closed at 520, urgent action on an order has been taken at 512, or market data for an order has been determined to be invalid at 506, process 500 can determine if there are other orders to be processed at 524. If so, process 500 can get data for the next order at 526 and then branch back to 506. Otherwise, process 500 can end at 528.

Returning to FIG. 2, after order(s) have been processed at 208, process 200 can determine whether any new orders have been received at 210. If any new orders have been received, the process can receive the new orders at 212 and update the model parameters (as described in connection with 408 of FIG. 4) for that order at 214. After these parameters have been updated, or if it is determined at 210 that there is no new order, process 500 can determine at 216 if the cycle period (e.g., one second) has ended. If not, the process can loop back to 210. Otherwise the process can determine at 218 if there are any open orders. If not, the process can loop back to 210. Otherwise the process can loop back to 208 to process the open orders.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A method for placing orders to trade a security, comprising:
receiving an order to trade a security;
determining an execution rate for the order;
determining a darkness threshold for the order;
selecting one or more routes for one or more working orders of the order based on at least the darkness threshold;
scoring the one or more routes;
allocating size to the one or more working orders based on the scoring and the execution rate;
creating the one or more working orders; and
sending the one or more working orders to the one or more routes for execution.

2. The method of claim 1, wherein the execution rate is based on an estimate of the market impact of the order based on historical data.

3. The method of claim 1, wherein the execution rate is based on an estimate of the real-time market impact of the order.

4. The method of claim 1, further comprising determining an order mode for the one or more working orders based on at least two of an actual percentage of volume rate, a target percentage of volume rate, a percentage of volume minimum rate, and a percentage of volume maximum rate.

5. The method of claim 1, wherein the darkness threshold is based on a calculation of a sensitivity of the order.

6. The method of claim 5, wherein the sensitivity is a price sensitivity.

7. The method of claim 5, wherein the sensitivity is a momentum sensitivity.

8. The method of claim 5, wherein the sensitivity is a risk sensitivity.

9. The method of claim 5, wherein the sensitivity is a tick sensitivity.

10. The method of claim 5, wherein the sensitivity is a spread sensitivity.

11. The method of claim 1, wherein selecting one or more routes comprises filtering a set of possible routes to obtain a subset of routes.

12. The method of claim 11, wherein the filtering includes applying a timer filter.

13. The method of claim 11, wherein the filtering includes applying a ticker filter.

14. The method of claim 11, wherein the filtering includes applying an open order filter.

15. The method of claim 11, wherein the filtering includes applying a minimum fill quantity filter.

16. The method of claim 11, wherein the filtering includes applying a post take mode filter.

17. The method of claim 11, wherein the filtering includes applying a flags filter.

18. A system for placing orders to trade a security, comprising:
at least one processor that:
receives an order to trade a security;
determines an execution rate for the order;
determines a darkness threshold for the order;
selects one or more routes for one or more working orders of the order based on at least the darkness threshold;
scores the one or more routes;
allocates size to the one or more working orders based on the scoring and the execution rate;
creates the one or more working orders; and
sends the one or more working orders to the one or more routes for execution.

19. The system of claim 18, wherein the execution rate is based on an estimate of the market impact of the order based on historical data.

20. The system of claim 18, wherein the execution rate is based on an estimate of the real-time market impact of the order.

21. The system of claim 18, wherein the at least one processor also determines an order mode for the one or more working orders based on at least two of an actual percentage of volume rate, a target percentage of volume rate, a percentage of volume minimum rate, and a percentage of volume maximum rate.

22. The system of claim 18, wherein the darkness threshold is based on a calculation of a sensitivity of the order.

23. The system of claim 22, wherein the sensitivity is a price sensitivity.

24. The system of claim 22, wherein the sensitivity is a momentum sensitivity.

25. The system of claim 22, wherein the sensitivity is a risk sensitivity.

26. The system of claim 22, wherein the sensitivity is a tick sensitivity.

27. The system of claim 22, wherein the sensitivity is a spread sensitivity.

28. The system of claim 18, wherein selecting one or more routes comprises filtering a set of possible routes to obtain a subset of routes.

29. The system of claim 28, wherein the filtering includes applying a timer filter.

30. The system of claim 28, wherein the filtering includes applying a ticker filter.

31. The system of claim 28, wherein the filtering includes applying an open order filter.

32. The system of claim 28, wherein the filtering includes applying a minimum fill quantity filter.

33. The system of claim 28, wherein the filtering includes applying a post take mode filter.

34. The system of claim 28, wherein the filtering includes applying a flags filter.

35. A computer-readable medium containing computer-executable instructions that, when executed by a processor, cause the processor to perform a method for placing orders to trade a security, the method comprising:
receiving an order to trade a security;
determining an execution rate for the order;
determining a darkness threshold for the order;
selecting one or more routes for one or more working orders of the order based on at least the darkness threshold;
scoring the one or more routes;
allocating size to the one or more working orders based on the scoring and the execution rate;
creating the one or more working orders; and
sending the one or more working orders to the one or more routes for execution.

36. The medium of claim 35, wherein the execution rate is based on an estimate of the market impact of the order based on historical data.

37. The medium of claim 35, wherein the execution rate is based on an estimate of the real-time market impact of the order.

38. The medium of claim 35, wherein the method further comprises determining an order mode for the one or more working orders based on at least two of an actual percentage of volume rate, a target percentage of volume rate, a percentage of volume minimum rate, and a percentage of volume maximum rate.

39. The medium of claim 35, wherein the darkness threshold is based on a calculation of a sensitivity of the order.

40. The medium of claim 39, wherein the sensitivity is a price sensitivity.

41. The medium of claim 39, wherein the sensitivity is a momentum sensitivity.

42. The medium of claim 39, wherein the sensitivity is a risk sensitivity.

43. The medium of claim 39, wherein the sensitivity is a tick sensitivity.

44. The medium of claim 39, wherein the sensitivity is a spread sensitivity.

45. The medium of claim 35, wherein selecting one or more routes comprises filtering a set of possible routes to obtain a subset of routes.

46. The medium of claim 45, wherein the filtering includes applying a timer filter.

47. The medium of claim 45, wherein the filtering includes applying a ticker filter.

48. The medium of claim 45, wherein the filtering includes applying an open order filter.

49. The medium of claim 45, wherein the filtering includes applying a minimum fill quantity filter.

50. The medium of claim 45, wherein the filtering includes applying a post take mode filter.

51. The medium of claim 45, wherein the filtering includes applying a flags filter.
